(19) United States
(12) Patent Application Publication
(10) Pub. No.: US 2015/0101197 A1
(43) Pub. Date: Apr. 16, 2015

(54) Safety Knife

(71) Applicant: KuoChen Feng, West Covina, CA (US)

(72) Inventor: KuoChen Feng, West Covina, CA (US)

(21) Appl. No.: 14/053,857

(22) Filed: Oct. 15, 2013

(51) Int. Cl. B26B 1/02

(52) U.S. Cl. CPC B26B 1/02
USPC 30/155

(57) ABSTRACT

A safety knife includes a handle plate. The handle plate is made of a planar sheet of steel. The handle plate is formed as a handle plate frame including a handle plate upper portion and a handle plate lower portion. The handle plate upper portion is connected to the handle plate lower portion at distal ends of the handle plate upper portion and handle plate lower portion. A blade has a blade edge for cutting. The blade is mounted so that it swivels between an open position and closed position. A blade pivot allows at least 180° swiveling and the blade is mounted to the blade pivot. The blade pivot is located on a first end of the handle plate. The handle plate further includes a handle plate action member extending from a second end of the handle plate.

### FIELD OF THE INVENTION

The present invention is in the field of the safety knife.

### DISCUSSION OF RELATED ART

A variety of different safety knife mechanisms have been used for allowing a compact folding knife that can fold open for usage and fold closed for storage.

### SUMMARY OF THE INVENTION

A safety knife includes a handle plate. The handle plate is made of a planar sheet of steel. The handle plate is formed as a handle plate frame including a handle plate upper portion and a handle plate lower portion. The handle plate upper portion is connected to the handle plate lower portion at distal ends of the handle plate upper portion and handle plate lower portion. A blade has a blade edge for cutting. The blade is mounted so that it swivels between an open position and closed position. A blade pivot allows at least 180° swiveling and the blade is mounted to the blade pivot. The blade pivot is located on a first end of the handle plate. The handle plate further includes a handle plate action member extending from a second end of the handle plate that is opposite the first end of the handle plate. The handle plate action member has an action member opening edge and an action member closing edge. The action member opening edge meets the action member closing edge at an angle. The handle plate action member closed position biases the blade into the closed position. The handle plate action member open position biases the blade into the open position.

A blade protrusion is configured to be biased into a closed position when the safety knife is in a closed position. The blade protrusion is configured to be biased into a partially open position of at least 45° when the safety knife is initially opened. Optionally, the blade protrusion extends from a plane of the blade and wherein the blade protrusion is cylindrical. The blade further includes a blade lower guard and a blade upper guard. The blade lower guard is configured to protrude from the handle plate when the blade is in the closed position.

The action member opening edge is formed at an angle to the action member upper edge and the action member lower edge. The action member upper edge is formed along an upper edge of the action member. The action member lower edge is formed along a lower edge of the action member. The action member closing edge is configured to abut a butt of the blade to prevent further opening rotation when the blade is pivoted to a fully open position.

It is an object of the invention to improve the design of the safety knife.

### BRIEF DESCRIPTION OF THE DRAWINGS

FIG. 1 is a front diagram view of the present invention with the knife in a partially open position.

FIG. 2 is a front diagram view of the present invention with the knife in closed position.

FIG. 3 is a perspective view of the handle plate.

FIG. 4 is a diagram of the knife in open position.

The following call out list of elements can be a useful guide in referencing the elements of the drawings.
20 Handle Plate
21 Tertiary Handle Plate Connection
22 Secondary Handle Plate Connection
23 Primary Handle Plate Connection
24 Grip Indent
25 Grip Protrusion
26 Handle Plate Upper Portion
27 Handle Plate Lower Portion
28 Handle Plate Action Member
29 Closing Notch
30 Blade
31 Handle Plate Lower Opening
32 Handle Plate Upper Opening
33 Action Member Opening Edge
34 Action Member Closing Edge
35 Action Member Upper Edge
36 Action Member Lower Edge
37 Blade Pivot
41 Blade Grip
42 Blade Edge
43 Blade Tip
44 Blade Lower Guard
45 Blade Protrusion
47 Blade Upper Guard
48 Blade Locking Detent

### DETAILED DESCRIPTION OF THE PREFERRED EMBODIMENT

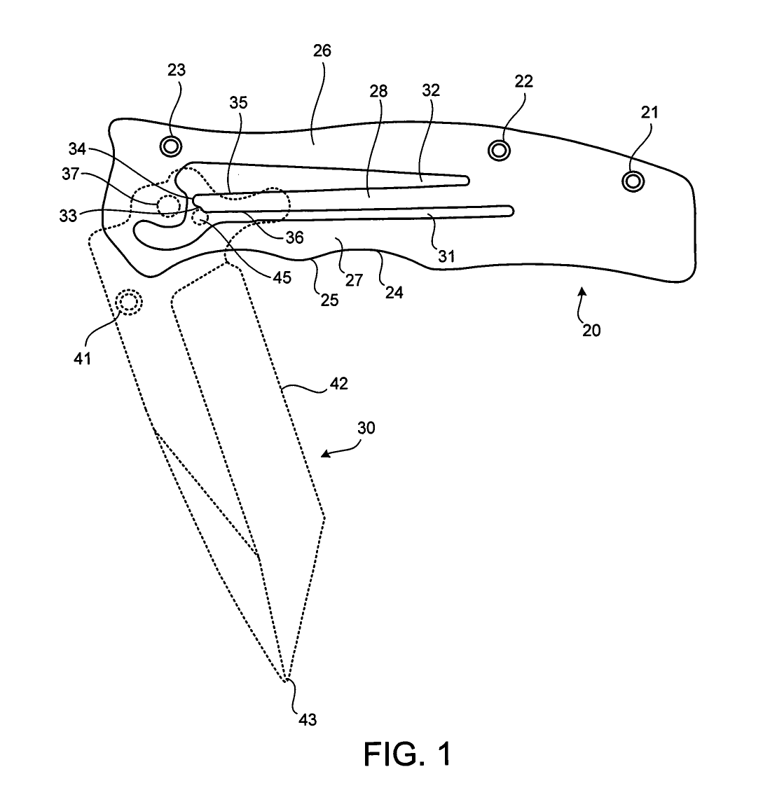

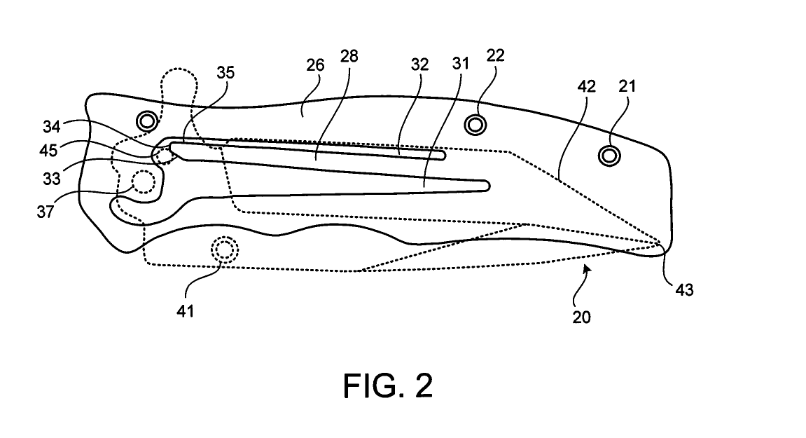

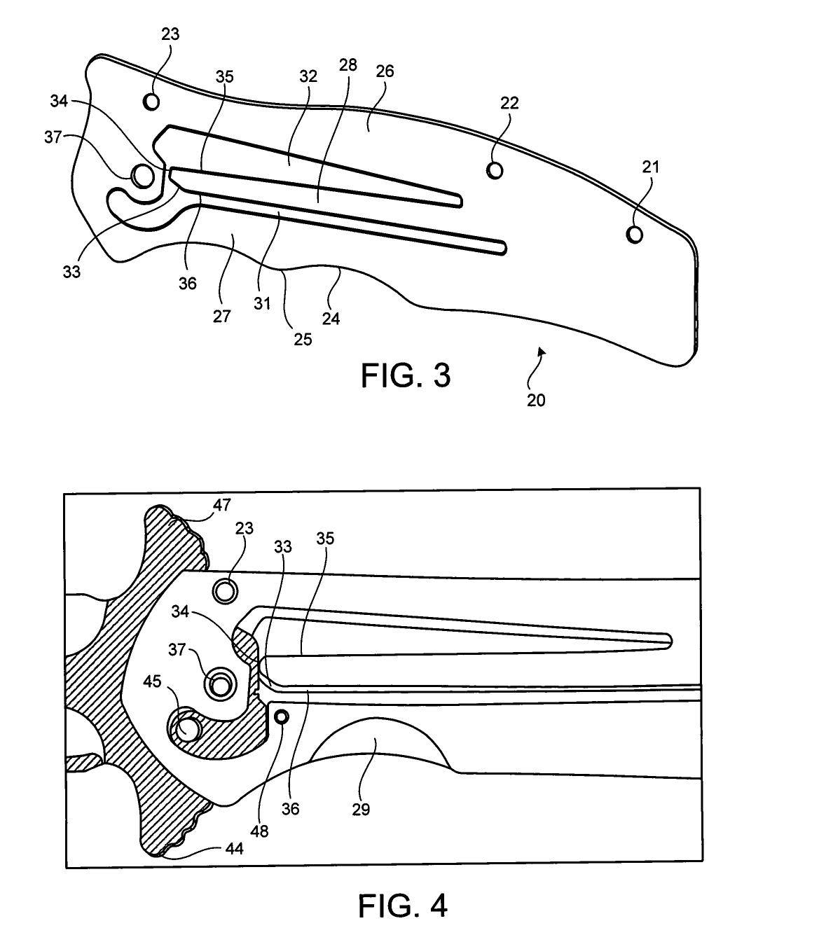

FIGS. 1-4 show an exploded view of the present invention which is a knife. The knife contains a bias mechanism designed to create a bias toward closure of the blade and that requires exertion applied to the blade by hand, wrist or arm to overcome the bias toward closure to assist in opening the knife. The safety knife has a handle plate 20 in pivotal connection with a blade 30. The handle plate has an aperture formed as a blade pivot 37 that connects the handle plate 20 pivotally to the blade 30. The safety knife has an open position and a closed position. In open position, the safety knife can be used. In the closed position, the safety knife requires that a user overcome a closing force to open the blade. Once the safety knife is partially open, a handle plate action member 28 assists in pushing the knife partially open.

The handle plate has at least three handle plate connections, namely a primary handle plate connection 23, a secondary handle plate connection 22, and a tertiary handle plate connection 21. The handle plate connections connect between the handle plate and a handle body. The handle body may have a grip that is ergonomically shaped for receiving user grip. The handle plate connections can be rivets or screws. The grip body has a grip indent 24, and preferably a pair of grip indents with a grip protrusion 25 between the grip indents. The grip protrusion 25 provides more control over the user grip of the knife. For clarity, the handle body is omitted from the drawings, but would be connected to the handle plate connections so that the blade would fit in the blade slot formed between the handle plate and the handle body. Both the handle body and the handle plate could have grip indents and grip protrusions.

The handle plate has a handle plate upper portion 26 and a handle plate lower portion 27. The handle plate upper portion and handle plate lower portion are connected at distal ends to form a frame of the handle plate. The handle plate supports a handle plate action member 28 within the frame of the handle plate. The handle plate action member 28 is connected at only one end to the handle plate. The handle plate action member 28 is peninsular with a handle plate upper opening 32 and a handle plate lower opening 31 above and below the handle plate action member 28. The action member is flexibly attached to the handle plate or integrally formed with the handle plate. Since the handle plate is formed of steel, the action member would be a steel portion of the handle plate. The action member thus has an action member upper edge 35 and an action member lower edge 36. The action member and the handle plate can be cut or punched from a sheet of steel.

The action member also has an action member opening edge 33 and an action member closing edge 34. The action member opening edge 33 is at an angle to the action member closing edge 34. When the knife is in closed position, the blade protrusion extends normally from a plane of the blade so that the action member engages the blade protrusion. In closed position, the action member biases the blade protrusion in a counterclockwise direction so that the knife biases into closed position. Further counterclockwise rotation of the knife can be stopped at where the blade lower guard 44 abuts the primary handle plate connection.

In opening the knife, a user may need to press hard on the blade lower guard 44, or pull out on the blade grip 41. After the user overcomes the closing bias, the cylindrical blade protrusion rolls over to the opening surface area of the action member opening edge. The knife then has an opening bias that moves the blade to an angle of approximately 60° or more as seen in FIG. 1.

The blade 30 has a blade edge 42. The blade edge 42 terminates at a blade tip 43. The blade 30 may have a blade lower guard 44 and a blade upper guard 47. The blade protrusion 45 engages with the handle plate action member 28 during closing and opening of the blade 30. The blade may optionally include a blade locking detent 48 that can be formed as a spring loaded ball bearing.

When the blade reaches a fully open position, the action member closing edge 34 may abut an inside surface of the blade 30 to prevent further clockwise rotation. The blade may also have a blade upper guard 47 that abuts the primary handle plate connection 23 to stop further clockwise rotation. To close the blade, a closing notch 29 can provide access to depress a portion of a locking spring that is seen as mounted in the closing notch 29. The locking spring may move to lock the blade in open position.

The above detailed description of the preferred embodiment is an example of an apparatus described by the following claims.

1. A safety knife comprising:
a. a handle plate, wherein the handle plate is made of a planar sheet of steel; wherein the handle plate is formed as a handle plate frame including a handle plate upper portion and a handle plate lower portion, wherein the handle plate upper portion is connected to the handle plate lower portion at distal ends of the handle plate upper portion and handle plate lower portion;
b. a blade having a blade edge for cutting, wherein the blade is mounted so that it swivels between an open position and closed position;
c. a blade pivot, wherein the blade is mounted to the blade pivot, wherein the blade pivot is located on a first end of the handle plate; wherein the handle plate further includes a handle plate action member extending from a second end of the handle plate that is opposite the first end of the handle plate, wherein the handle plate action member has an action member opening edge and an action member closing edge, wherein the action member opening edge meets the action member closing edge at an angle, wherein the handle plate action member closed position biases the blade into the closed position, wherein the handle plate action member open position biases the blade into the open position.

2. The safety knife of claim 1, wherein a blade protrusion is configured to be biased into a closed position when the safety knife is in a closed position, and wherein the blade protrusion is configured to be biased into a partially open position of at least 45° when the safety knife is initially opened.

3. The safety knife of claim 1, wherein the blade protrusion extends from a plane of the blade and wherein the blade protrusion is cylindrical.

4. The safety knife of claim 1, wherein the blade further includes a blade lower guard and a blade upper guard, wherein the blade lower guard is configured to protrude from the handle plate when the blade is in the closed position.

5. The safety knife of claim 1, wherein the action member opening edge is formed at an angle to the action member upper edge and the action member lower edge, wherein the action member upper edge is formed along an upper edge of the action member and, wherein the action member lower edge is formed along a lower edge of the action member.

6. The safety knife of claim 1, wherein the action member closing edge is configured to abut a butt of the blade to prevent further opening rotation when the blade is pivoted to a fully open position.

7. The safety knife of claim 6, wherein a blade protrusion is configured to be biased into a closed position when the safety knife is in a closed position, and wherein the blade protrusion is configured to be biased into a partially open position of at least 45° when the safety knife is initially opened.

8. The safety knife of claim 6, wherein the blade protrusion extends from a plane of the blade and wherein the blade protrusion is cylindrical.

9. The safety knife of claim 6, wherein the blade further includes a blade lower guard and a blade upper guard, wherein the blade lower guard is configured to protrude from the handle plate when the blade is in the closed position.

10. The safety knife of claim 6, wherein the action member opening edge is formed at an angle to the action member upper edge and the action member lower edge, wherein the action member upper edge is formed along an upper edge of the action member and, wherein the action member lower edge is formed along a lower edge of the action member.
